(19) United States
(12) Patent Application Publication
(10) Pub. No.: US 2026/0163879 A1
(43) Pub. Date: Jun. 11, 2026

(54) USING A NATIVE LOGIN SCREEN TO BOOT TO A VIRTUAL APPLICATION

(71) Applicant: Microsoft Technology Licensing, LLC, Redmond, WA (US)

(72) Inventors: Christiaan BRINKHOFF, Woodinville, WA (US); Zachary Cole WILLSON, Redmond, WA (US); Geanina Luiza Valentina ANDREIU, Redmond, WA (US); Amar Dinesh ZAVERY, Redmond, WA (US); Serena Jawen ZHENG, Madison, WI (US); Derek Xianyang LIU, Cary, NC (US)

(21) Appl. No.: 18/974,525

(22) Filed: Dec. 9, 2024

(51) Int. Cl. H04L 9/40; G06F 9/451

(52) U.S. Cl. CPC H04L 63/083; G06F 9/452

(57) ABSTRACT

Techniques for accessing a virtual application from a local device's initial login screen and reconfiguring the device's operating system (OS) to integrate access to a remote virtual desktop are disclosed. Booting directly to a virtual application enables a streamlined, highly convenient method for becoming productive on a cloud application. The system displays a login screen that is native to the system's OS. User credentials for a remote virtual desktop are received at the login screen. These credentials are used to identify the user and the user's corresponding remote virtual desktop. The virtual application is selected from a host pool on the virtual machine. A stream of an image of the application is then received and displayed. Therefore, despite the virtual application residing in the cloud environment, the virtual application can be accessed directly from the native login screen of the user's local device.

### BACKGROUND

There are various forms of computing, including local and remote computing. One type of remote computing is referred to as “cloud computing.” Cloud computing generally refers to a technique for providing real-time delivery of or access to various remote computing services, infrastructure, and/or computing resources. Running applications on the cloud rather than on a local device provides numerous benefits, such as cost efficiency for resources like compute power and storage, easier collaboration with large teams, and environmental and energy conservation.

Cloud computing environments often include a large number of servers or computing devices that host virtual machines. These virtual machines can also host their own respective set of virtual applications. A “virtual application,” as used herein, simply refers to a type of application that is executing on a virtual machine.

To access a virtual application with conventional techniques, a user first logs into her personal or local computer device with a first set of credentials to access the various resources of the local device. After the user has logged into her local device with her first set of credentials, the user can subsequently select and log into a cloud service by entering a second set of credentials that are associated with the cloud services. Then, after the user has logged into a remote virtual desktop using her second set of credentials, she can select and log into a specific virtual application from the remote virtual desktop.

For example, after first logging into a local device, the user can access a cloud services portal, dashboard, or application interface on the local device to then enter a second set of credentials that are associated with her cloud service(s). Then, after entering her second set of credentials into the portal, the user is provided access to the various resources and applications made available by the cloud services through a remote virtual desktop on a virtual machine that operates remotely from the local device. From here, the user may select a specific application on the remote virtual desktop. Sometimes, the application may also require a log in step; in this case, the user enters a third set of credentials before she can use her application.

As used herein, the phrase “remote virtual desktop” refers to a user interface for a virtual machine. The phrase “virtual machine” refers to a computing resource that relies on abstracted software that is utilizing resources of a physical computer. Such remote configurations can also be referred to more broadly as “alternate systems” and can include any type of virtual machine or any other remote computing system that is accessible through a local device.

When a user's local machine is simply being used to access a cloud virtual machine or a cloud application, the user's local, physical device is effectively operating as a dummy terminal interface for the remote virtual machine provided by the remote cloud services, where the user interacts with the virtual machine through that machine's virtual desktop but through the user's local periphery devices (e.g., mouse, keyboard, display, speakers). In the context of a remote virtual desktop hosted on a virtual machine, the user's local device streams an image of the remote virtual desktop to the physical display of the local device. Applications on a remote virtual desktop are often managed through a cloud service. In such scenarios, the compute, memory, and other computing operations performed by the virtual machine are primarily performed in the cloud, remotely from the user's local device; the local device is essentially a streaming device to visualize the remote virtual desktop and the applications that the virtual machine runs in the cloud.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for configuring a login screen, which is native to an operating system (OS) of a computer system, to enable a user to access a virtual application that is hosted by a virtual machine residing in a cloud environment. This access is provided via a single login process and is provided without requiring multiple sequential login sessions (e.g., without requiring a user to first log into her local device with a first set of credentials prior to logging into a virtual session with a second set of credentials and, potentially, to an application with a third set of credentials), where the virtual application is either selected intelligently by the embodiments or selected by the user.

In some aspects, the techniques described herein relate to a computer system that facilitates user access to an application on a remote virtual desktop, said computer system including: one or more processors; and one or more hardware storage devices that store instructions that are executable by the one or more processors to cause the computer system to: display a login screen, which is native to an operating system (OS) of the computer system; receive user credentials via the login screen, wherein the user credentials are for the remote virtual desktop, and wherein the remote virtual desktop is associated with the application and a user from whom the user credentials are received; authenticate the user credentials over a network connection; after authenticating the user credentials, launch the remote virtual desktop; suppress a display of the remote virtual desktop; while the display of the remote virtual desktop is being suppressed, launch the application and display a user interface of the application on a display of the computer system.

In some aspects, the techniques described herein relate to a method to facilitate user access to an application on a remote virtual desktop, said method including: displaying a login screen, which is native to an operating system (OS) of a computer system; receiving user credentials via the login screen, wherein the user credentials are for the remote virtual desktop, and wherein the remote virtual desktop is associated with the application and a user from whom the user credentials are received; authenticating the user credentials over a network connection; identifying the remote virtual desktop and the application on the remote virtual desktop; after authenticating the user credentials and identifying the remote virtual desktop and the application, launching the remote virtual desktop; suppressing a display of the remote virtual desktop; while the display of the remote virtual desktop is being suppressed, launching the application, which is hosted by the remote virtual desktop, and displaying the application on a display of the computer system.

In some aspects, the techniques described herein relate to one or more hardware storage devices that store instructions that are executable by one or more processors to cause the one or more processors to: display a login screen, which is native to an operating system (OS) of a computer system of the hardware storage devices and one or more processors; receive user credentials via the login screen, wherein the user credentials are for a remote virtual desktop, and wherein the remote virtual desktop is associated with an application and a user from whom the user credentials are received; authenticate the user credentials over a network connection; after authenticating the user credentials, launch the remote virtual desktop; suppress a display of the remote virtual desktop; while the display of the remote virtual desktop is being suppressed, launch the application, which is hosted by the remote virtual desktop, and display the application on a display of the computer system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the present techniques may be realized and obtained by means of the instruments and combinations particularly pointed out in the appended claims. Features of the present techniques will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture that can be used to connect to a remote application from the native login screen of a computer system.

FIG. 2 illustrates an example connection protocol to boot to an application on a remote virtual desktop.

FIG. 3 illustrates an example of a login screen on a local device with a first type of operating system.

FIG. 4 illustrates an example of a login screen with username and password fields auto-populated from a password manager service.

FIG. 5 illustrates an example of a login screen with tiles to select an application hosted on a remote virtual desktop.

FIGS. 6A and 6B illustrate examples of login transition screens displayed while an application is loading and suppression of a remote virtual desktop.

FIG. 7 illustrates an example of an application being a web browser on a remote virtual desktop with features of a non-native OS.

FIG. 8 illustrates an example of a global log-off feature.

FIG. 9 illustrates an example process flow outlining operations that can be performed to connect to an application on a remote virtual desktop.

FIG. 10 illustrates an example architecture of a device that can connect to an application on a remote virtual desktop.

FIGS. 11 and 12 illustrate various flowcharts of example methods for configuring a login screen to enable a device to connect to a virtual application from that native login screen.

FIG. 13 illustrates an example computer system that can be configured to perform any of the disclosed operations.

### DETAILED DESCRIPTION

Embodiments disclosed herein relate to systems, devices, and methods that beneficially integrate a user's access to an application on a remote virtual desktop with a local device's operating system (OS) to allow a streamlined, highly efficient technique for accessing the remote virtual desktop via the local device's native login screen.

Advantageously, the embodiments provide a technique to login directly to a remote application operating in a cloud environment, where the login occurs at the local device's native login screen. In other words, the embodiments provide an efficient process for gaining access to and using a virtual application by eliminating multiple sequential logins and by streamlining the loading process. The embodiments provide significant improvements over both the traditional method of gaining access to an application on a local desktop and methods of using an application on a remote virtual desktop, by enabling a user to log into the application directly from a login screen on the local device. Additionally, the embodiments improve how a user interacts with a computer system when that user's objective is to log into a specific remote application.

As mentioned previously, the phrase “virtual application” refers to an application that is hosted on a virtual machine in a cloud environment. The virtual application is also commonly referred to as a “cloud application” or a “remote application.” For simplicity, the application described herein is a virtual application. The virtual application may be a software as a service (SaaS) application; an infrastructure as a service (IaaS) application; a platform as a service (PaaS) application; a web browser; a specific application or program, including one that has a previously saved state; or any other type of virtual application.

The embodiments herein cause the computer system to display the login screen, which is native to the computer system's OS. As used herein, the term “native” refers to a computing function, feature, interface, application, or any other computing aspect that is designed to operate on a specific platform, such as an operating system, executing on a local device. Thus, an operating system typically includes a login screen that is native to that operating system. User credentials are received at the login screen. The user credentials are used to identify, over a network connection, an application on a corresponding remote virtual desktop. A stream of an image of the application is received over the network connection and displayed on the display of the computer system. Therefore, despite the virtual machine hosting the remote virtual desktop in the cloud environment, the virtual application for that virtual desktop can still be accessed via the local computer system's login screen.

By way of further detail, the embodiments display a login screen that is native to the system's OS. User credentials are received at the login screen. When the entered credentials correspond to a local desktop, the system validates the credentials and provides the user access to her local desktop instead of to a remote application. Alternatively, when the user credentials correspond to a remote virtual desktop or cloud service, the system interfaces with a service to validate the credentials and to provide access to the application that is associated with the remote virtual desktop for the validated credentials.

In some instances, a first application shell of the computer system's OS, which is of a first type, activates the service tasked with identifying, over a network connection, the remote virtual desktop and application and validating the user's credentials to the remote virtual desktop. Once the virtual session is initiated, after validating the user's credentials, a stream of an image of the corresponding application is received over the network connection while display of the remote virtual desktop is suppressed. The user then interacts with a second application shell, which is associated with an OS of the remote virtual desktop of either the first or a second type, to control interactions with the application. This interaction occurs using a remote connection that exists between the computer system and the virtual machine that is hosting the remote virtual desktop and application, and that was established as a result of the user entering the validated user credentials for the virtual session at the native login screen.

While conventional systems may provide a “kiosk mode,” selectively controlling a device so that the device is able to run a single application, akin to a sandbox mode, such systems have a number of limitations. A computer running in kiosk mode is heavily restricted in its overall operations, while a remote virtual desktop is not. Additionally, kiosk mode is configured to operate with local resources in a single manner, independent of the login credentials that are provided. In contrast, a remote virtual desktop is associated with remote resources that are only available through a virtual session that is enabled after a user enters a set of credentials to log into her remote virtual desktop. Further, in a kiosk mode, the user typically cannot select an application, as the device is configured to run only a single application. Conversely here, even if there is a preferred common application that is typically used, in most embodiments, the user has the option to select an application from many cloud applications or the user has previously set a default application to open.

In the present techniques, the cloud service providing the remote virtual desktop and application provides an experience designed to mimic the experience the user would have if the user were interacting only with her local device. However, the remote virtual experience has numerous benefits over the traditional local device, both for individual users and organizations. For example, the remote virtual desktop, including a host pool of virtual applications, may be managed quite easily from an information technology (IT) perspective. Another benefit includes easily scaling computer requirements, memory, and other computing resources. These and other benefits will be described in further detail below.

As noted previously, the conventional manner in which a user gains access to her cloud application is as follows. First, the user logs onto her local device with a first set of credentials. Once logged on, the user navigates to an application dashboard or portal that allows the user to access the remote virtual desktop. The user then enters her second set of credentials to gain access to that remote virtual desktop. The remote virtual desktop is streamed to the user's local device and then the user may interact with the remote virtual desktop directly. From the remote virtual desktop, the user then selects a virtual application, and logs into the application if needed, potentially entering a third set of credentials.

In some other instances, the user has a pre-provisioned remote virtual desktop that does not require credentials from a specific local device that is known to be associated with the user. In this instance, the user experience would be to login locally, open an application or portal that includes virtual applications, and launch a selected virtual application; then, potentially enter a second set of credentials to gain access to the application. In this regard, traditional techniques still require the implementation of multiple sequential login sessions, each being associated with different sets of unique credentials or a lengthy navigation process for a user to access their application. This can create confusion and unnecessary delay for users attempting to log into an application on a remote virtual desktop. For at least these reasons, there is an ongoing need and desire for new and improved techniques for enabling users to log into their cloud applications from a local device.

Commonly, some workers in specific industries like retail, manufacturing, education, finance, or healthcare work primarily with a single application. Streamlining the process of logging into a cloud application enables a user to become productive faster. For example, a nurse in a hospital usually works with one application, but may have several workstations in different locations or on different devices across the hospital. To log into their preferred application, they may have to go through several sequential log in steps each time they change workstations throughout the day, detracting from productivity. As brief further examples, a retail worker may only use a single point of sale application or similarly, a finance broker may use only one trading application. In both cases, a multi-step logon process and navigation to the desired application is inefficient.

Additionally, booting directly to an application from a local login screen provides benefits for efficiency in computing systems, and streamlines infrastructure and management. IT administration updates, maintenance, and control are easier to implement when applications are mainly used in a cloud environment. In addition, data maintenance, backup, and recovery are achieved more easily in a cloud environment. Having application data in the cloud environment may contribute to both efficiency and speed of running a virtual application. As a specific example, in most embodiments, the virtual application and the remote virtual desktop are hosted on a single virtual machine, which contributes to efficient computing.

With traditional virtual desktop infrastructure (VDI) implementations and even with kiosk mode implementations, users are required to perform numerous different steps (i.e. multiple login actions) to access their applications on their remote virtual desktops, where these steps create friction on the part of the user. For instance, that friction often involves users having to launch additional client applications or to perform complex actions to access the virtual sessions on a remote virtual desktop where the application would be hosted, before even logging into the application. Thus a main benefit to the embodiments described herein over traditional systems is that the integration with the device's local shell enables the embodiments to display a more integrated transition from local to cloud and a user experience that smoothly delivers the user to their end application with a single set of login credentials that can be entered at the first stage of interaction with the user's local device (e.g., at the initial login screen that is native to the local device).

The disclosed embodiments provide a streamlined login process that requires fewer actions to access virtual desktop resources, including a host pool of virtual applications. Stated differently, the efficiencies of both the user and of the computer system are often improved because fewer user-facing actions are performed to access that user's preferred virtual application. However, it will be appreciated by those with skill in the art that many features of the user's local device can also be used to support and supplement the processes and data being used in the application and on the remote virtual desktop.

By implementing the disclosed principles, users will be able to become more productive more quickly by logging into an application directly. In this way, it will typically be the case that a user will not discern any difference in actions or procedures with regard to logging into that user's physical computer, such that users will be able to easily adopt the disclosed techniques because the underlying operations are hidden from the user. The user is then greatly benefitted because they can now more easily access an application with a single login process, rather than requiring multiple login processes or launching a separate portal or interface.

Whereas the traditional techniques to use a cloud application require multiple login and navigation steps for the user to follow, the disclosed embodiments beneficially eliminate many of these steps from the perspective of the user. Now, the user sees a single login screen and enters one set of credentials before being able to use their application. Accordingly, these and numerous other benefits will now be described in more detail throughout the remaining sections of this disclosure.

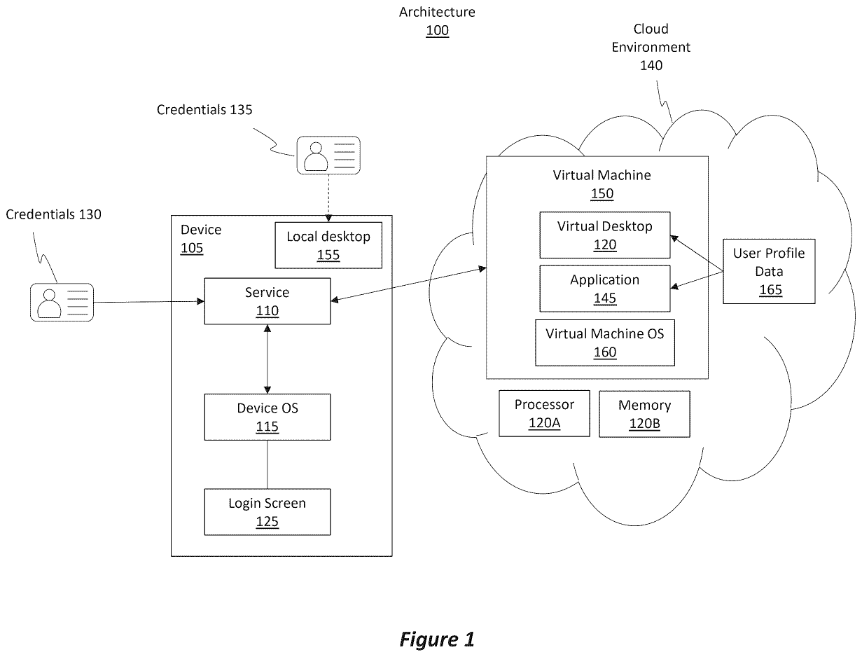

Having just described some of the various high level benefits provided by the disclosed embodiments, attention will now be directed to FIG. 1, which shows an example architecture 100 that can be used to achieve those benefits. Architecture 100 shows a device 105 that includes a local desktop 155 and a service 110. Device 105 can be any type of computing device, including but not limited to any type of personal computer (PC), mobile device, tablet, and so on.

As used herein, the term “service” refers to an automated program that is tasked with performing different actions based on input. In some cases, service 110 can be a deterministic service that operates fully given a set of inputs and without a randomization factor. Additionally or alternatively, service 110 can be or can include a machine learning (ML) or artificial intelligence engine.

As used herein, reference to machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees), linear regression model(s), logistic regression model(s), support vector machine(s) (“SVM”), artificial intelligence device(s), or any other type of intelligent computing system. Any amount of training data may be used (and later refined) to train the machine learning algorithm to dynamically perform the disclosed operations.

In some implementations, service 110 is a cloud service operating in a cloud environment 140. However, typically, service 110 is a local service operating on a local device, such as the device 105. In some other implementations, service 110 is a hybrid service that includes a cloud component operating in the cloud environment 140 and a local component operating on the device 105. These two components are enabled to communicate with one another. Service 110 is able to communicate and, in some examples, augment an OS of the local device, such as device OS 115. Furthermore, service 110 can cause an application programming interface (API) and/or a client application to be implemented with or alongside the device OS 115. In some instances, the service 110 itself can also be referred to as a client application. As used herein, the term “API” refers to a set of protocols that are used to enable one application or component to interact and engage with another application or component.

Device OS 115 may include a shell application. As used herein, the phrase “shell application” or simply “shell” refers to a program or application that exposes the device's OS to another program or application or component to enable that other application (or component) to access the OS in various different ways. The shell can also be considered the outermost layer of the device's OS.

The service 110 is enabled to communicate with the shell. Service 110 may be tasked with performing various operations related to connecting with a virtual application, as will be discussed in more detail herein. In this regard, service 110 may cooperate and communicate with the device's OS, and in particular with the OS's shell, and can perform various actions with regard to connecting with a virtual application.

The device OS 115 includes or provides a login screen 125, where a user enters her credential information for logging into an application associated with a remote virtual desktop 120 (when the virtual desktop credentials 130 are entered), or optionally, for logging into the local desktop 155 (when the local desktop credentials 135 are entered). The login screen 125 is local or native to the device OS 115, where the login screen is conventionally only used to receive credentials for logging into the local desktop 155.

In accordance with the disclosed principles, the login screen 125 that is native to the local device is now configured to enable a user to enter her virtual desktop credentials 130 in the login screen 125 and to be able to cause the device to connect with that user's preferred application 145 associated with the remote virtual desktop 120 of a virtual machine 150. Thus, the user can enter one set of credentials into the local or native login screen 125, and the computer system can be triggered to directly connect to that user's preferred application 145. The selection of the preferred application 145 that is associated with the remote virtual desktop 120 will be discussed further below.

Virtual machine 150, which includes the remote virtual desktop 120, application 145, and virtual machine OS 160, resides in a cloud environment 140. The virtual machine 150 is able to utilize any number of processors or memory storage components provided in the cloud environment 140, as shown by processor 120A and memory 120B. The virtual machine is also able to utilize user profile data 165, which may be associated with the virtual desktop 120 and/or the application 145.

In some implementations, the cloud environment 140 stores user profile data 165 that corresponds to user profile data associated with the remote virtual desktop 120 and/or the application 145. Storing user profile data 165 in the cloud environment 140 is beneficial to save time and efficiency. The application 145 may also maintain the user profile data 165. In some embodiments, launching the application 145 may include fetching the user profile data 165.

To log into an application 145 on the remote virtual desktop 120 from the device 105, the user enters her credentials 130, which are credentials associated with the remote virtual desktop 120, into the login screen 125. The service 110 then streams an image of the application 145 that is associated with the remote virtual desktop 120 for display on the device 105. The user is then provided with a direct way to interact with a remote application 145 from the cloud environment 140. Alternatively, the user may enter credentials 135, corresponding to the local desktop 155 of the device 105, to access and interact with their local desktop 155.

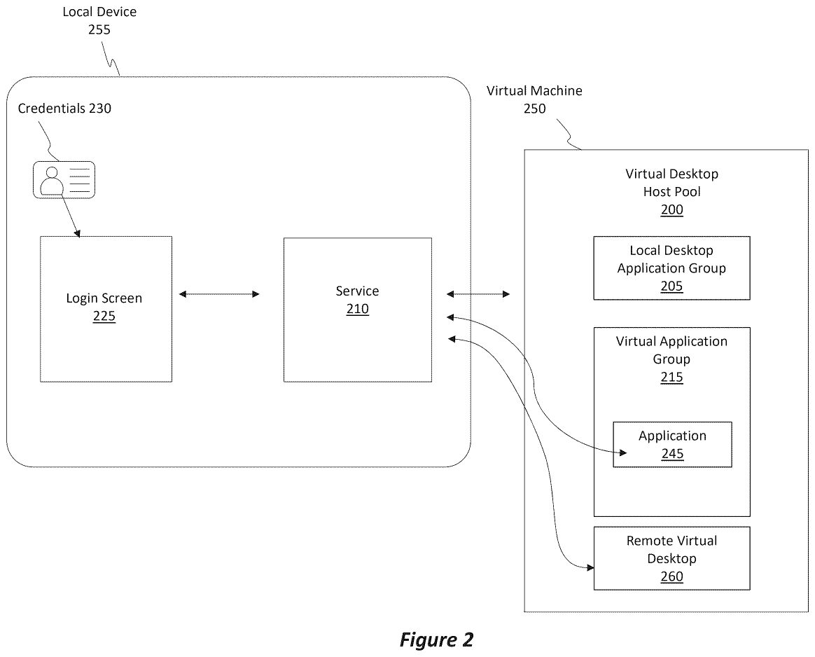

FIG. 2 shows an example connection protocol for connecting directly to an application on a remote virtual desktop from a native login screen 225 on a local device 255. First, credentials 230, corresponding with a remote virtual desktop of a virtual machine 250, are entered into the login screen 225. Then, service 210 communicates with the virtual machine 250 that resides in a cloud environment. Service 210 may be representative of service 110 of FIG. 1, while the virtual machine 250 may be representative of the virtual machine 150.

Virtual machine 250 includes a remote virtual desktop 260 for user interaction. The embodiments beneficially provide a virtual desktop host pool 200 that includes both a local desktop application group 205 and a virtual application group 215, which includes the application 245 that is the user's preferred virtual application. Conventionally, the local desktop application group 205 and virtual application group 215 are hosted separately; however, here one significant improvement to the field is found in including both application groups on the same virtual desktop host pool, providing the user with more options and creating efficiencies in the computing system, such as by avoiding cross-device network communications in situations where the local desktop application group 205 is hosted on a first network device and the virtual application group 215 is hosted on a second network device. Beneficially, the same single virtual machine 250 hosts both the virtual desktop and the preferred application 245, thereby avoiding situations in which the preferred application 245 is hosted by an entity that is different than the one hosting the virtual desktop.

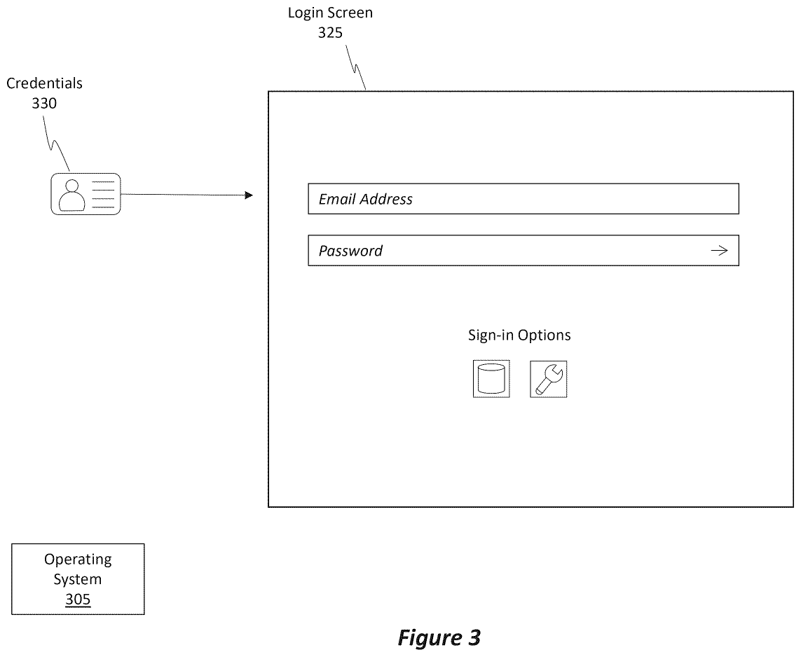

FIG. 3 shows an example of a login screen on a local device with a first type of operating system 305. Login screen 325 may be representative of the login screen 125 of FIG. 1 or the login screen 225 of FIG. 2. The user can enter her credentials 330 on the login screen 325; the credentials 330 can include credentials for accessing the remote virtual desktop or credentials for accessing the local or native desktop. In most cases, the credentials 330 comprise a username and a password, but in some other instances, credentials 330 may include a license code or a quick response (QR) code, fingerprint or other biometric data, or voice code. For example, it may be the case that the user does not have a pre-provisioned remote virtual desktop. In such a scenario, the user may purchase a license code. The user can then enter the license code into the login screen 325. Entering this license code into the login screen 325 can operate as a triggering mechanism to provision a remote virtual desktop for the user.

FIG. 3 also shows the login screen 325 to be operating on an operating system 305 of a first type that is native to the local device. In some embodiments, the login screen includes various features, such as a task bar, control features, folder(s), or file options, and so on that are also native to the local device's operating system 305. Optionally, the login screen 325 can include sign in options to connect to the local desktop of the local device.

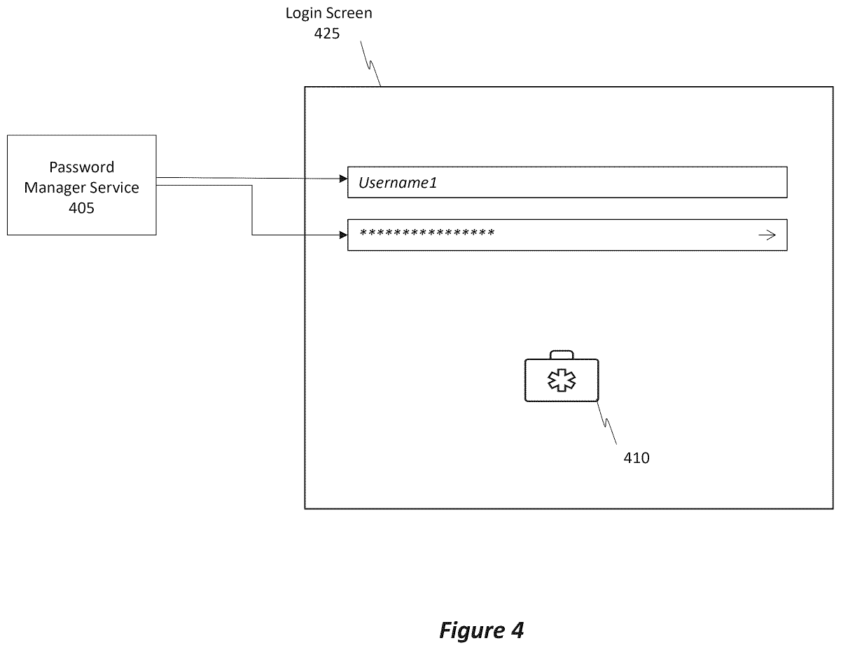

FIG. 4 shows an alternative example login screen 425, similar to the login screen 325 of FIG. 3. In this implementation, a password manager service 405 automatically populates the credential fields on the screen's username field and password field. The auto populated username and password may be stored in the password manager service on the local device or included in user profile data stored in the cloud environment.

The login screen 425 shows an icon 410 for an application; in this example, the icon 410 represents the default virtual application. In other words, the user's preferred application associated with the remote virtual desktop will load after the user's credentials, in this case provided by the password manager service 405, are entered on the login screen 425. In response to the credentials being entered, the embodiments operate on those credentials to facilitate the authentication of the user. Such operations include, but are not limited to, verifying the username is valid, verifying the password is valid, and/or verifying the combination of the username and password is valid. The icon 410 for the application may be selected as the preferred application by a user configuration, or alternatively, by an IT administrator in a prior setup process. For example, if the device is a personal device but the user mainly works with only one virtual application, they may set a default application to load after entering their credentials for the remote virtual desktop. In a contrasting example, if the device is a company owned device, an IT administrator may set the default virtual application. The virtual application is associated with a specific remote virtual desktop on a virtual machine. The embodiments beneficially provide a method to open and use the application without interacting with the remote virtual desktop.

The remote virtual desktop is associated with a specific virtual application. In some embodiments, the remote virtual desktop determines which virtual application will be opened without a prior default selected. In this case, the virtual applications in a certain host pool for the user's remote virtual desktop may be ranked based on any metric. For example, the virtual application that is opened may be the most used application, the most commonly used on start application, or the application that was open in the most recent cloud session. Options can be provided to the user to switch between different applications. For instance, in some cases, a drop-down menu can be displayed to allow the user to switch among any number of different applications.

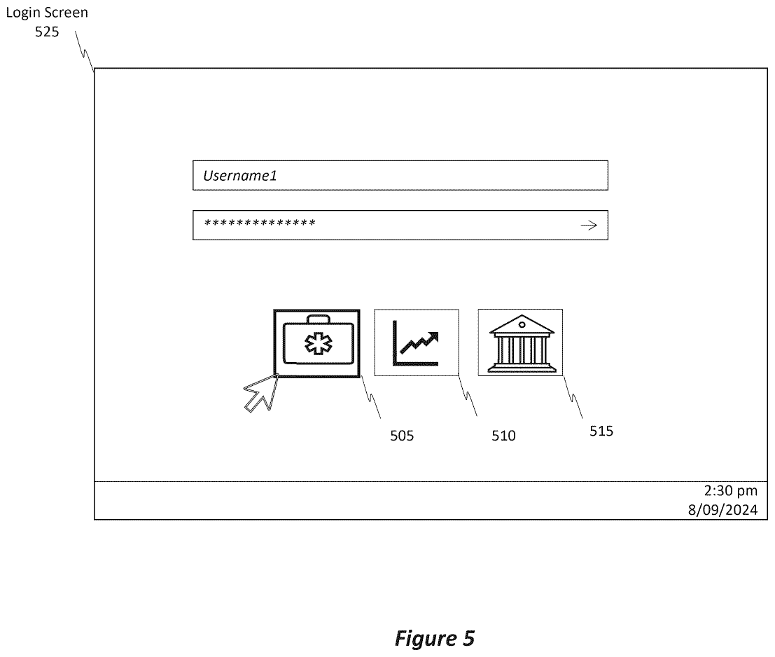

Alternatively, in some implementations the application is selected from a list of applications or application elements which may be associated with the same remote virtual desktop or several different remote virtual desktops. FIG. 5 shows an example of an embodiment with three application tiles 505, 510, and 515 displayed simultaneously on the login screen 525. Application tile 505 is highlighted as it is selected, such that after the credentials for the user's remote virtual desktop are entered and validated (e.g., authenticating the credentials by checking to determine whether the entered username and password combination are recognized as being acceptable), the application corresponding to application tile 505 will load. If a different tile were selected, the application corresponding to that tile would be the one that loads.

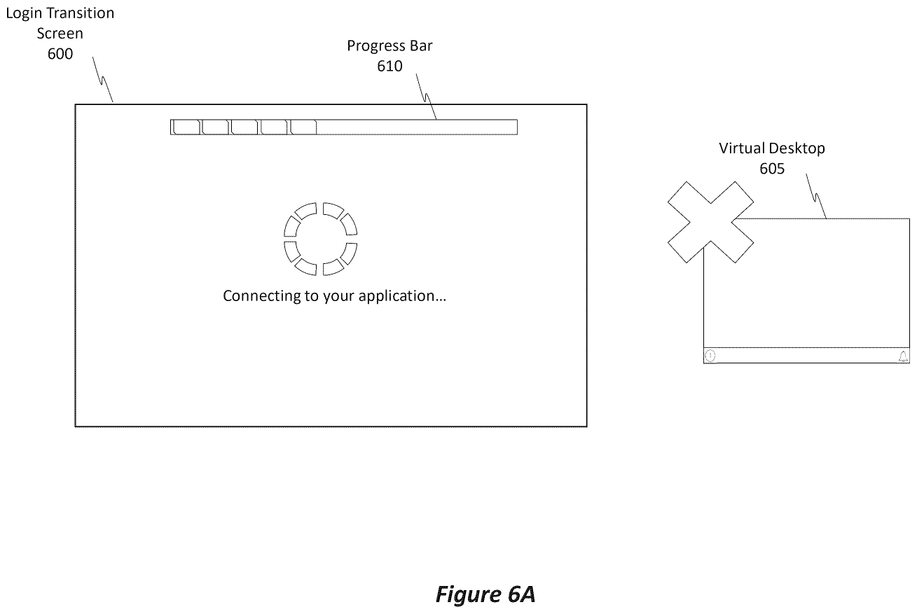

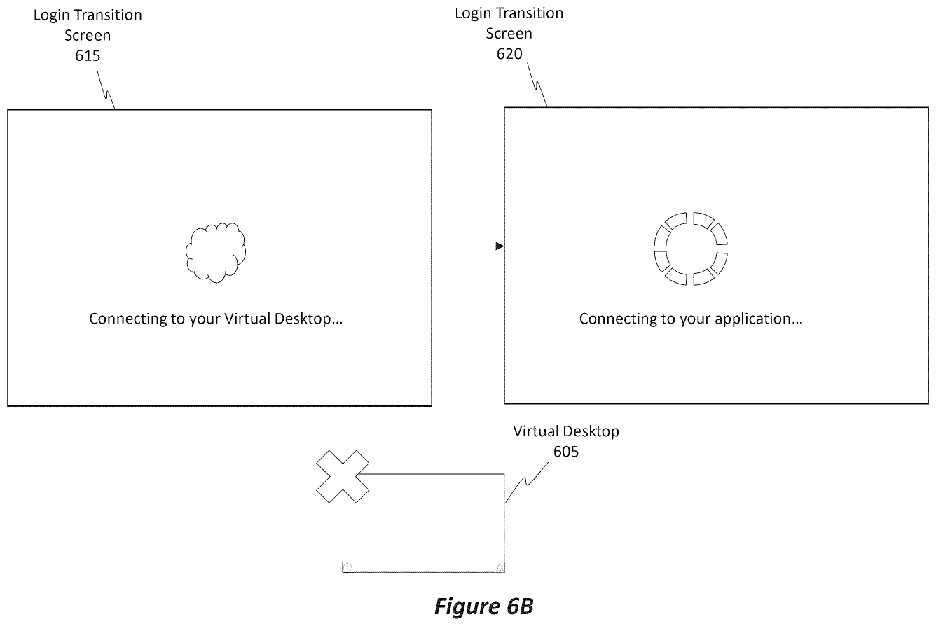

In some embodiments, a login transition screen is displayed while the computer system is connecting to the virtual application, after a user has entered her remote virtual desktop credentials. FIGS. 6A and 6B show examples of login transition screens that are displayed while an application is loading.

In some embodiments, the login transition screens are designed to mimic similar loading screens that are displayed while a user natively logs into a local device. FIG. 6A shows a single login transition screen 600. In some embodiments, the login transition screen 600 includes an element which displays the status of the loading process of the virtual application, for instance, progress bar 610. The login transition screen can optionally include a user interface element indicating the connection status between the local computer system and the remote server hosting the user's virtual desktop.

Similarly, FIG. 6B shows sequential login transition screens 615 and 620 that display the progress of connecting to a virtual application. First, the system displays login transition screen 615 while the service is connecting to the virtual desktop; then, the system displays login transition screen 620 while the service is connecting to the specific remote application.

Notably, while the application is loading, display of the remote virtual desktop 605 is being suppressed. For instance, in some embodiments, the user does not ever see or interact with the remote virtual desktop 605, as represented by the large X in both FIGS. 6A and 6B. Stated differently, the disclosed embodiments suppress or prevent all or a portion of the display of the virtual machine's desktop while the virtual application is loading even though, in some embodiments, the virtual machine loads first and then the virtual application loads. In some scenarios, a limited portion of the virtual machine's desktop may be displayed during the loading process. As one example, the limited portion may include a task bar, a menu screen, a search feature, or some other limited feature of the virtual machine's desktop. As another option, the background image or window of the virtual machine's desktop may be displayed during the loading process. For instance, it may be the case that a personalized image is used for the virtual machine's background. This personalized image may be displayed during the loading process. Some embodiments fully suppress the display of the virtual desktop, and the loading screen is caused to be displayed until such time as the virtual application's landing screen or startup screen is displayed.

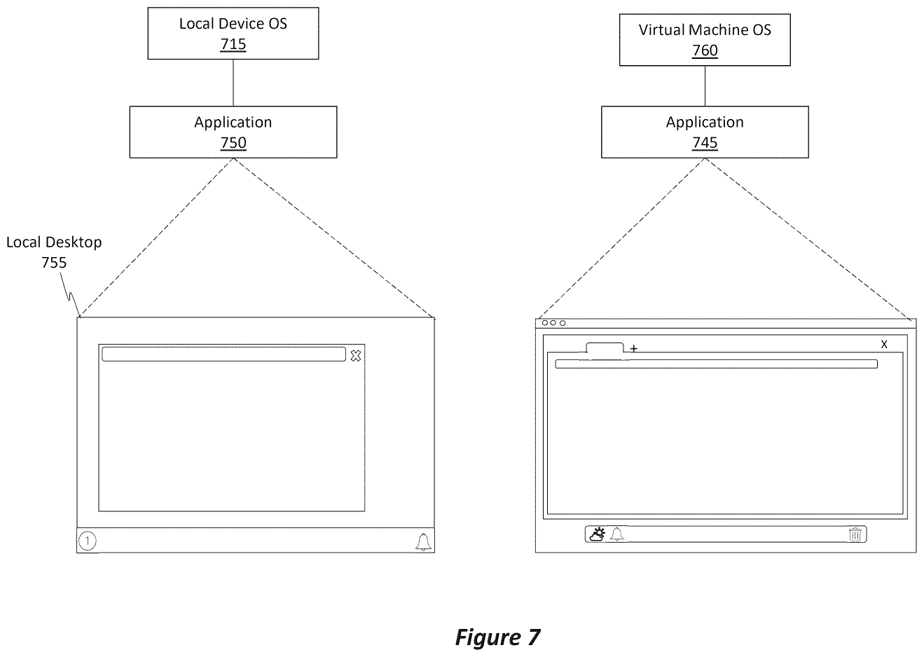

In some embodiments, the application does not have the same aesthetic features as it would if it were displayed on the local device OS. FIG. 7 shows a comparison of two applications 750 and 745 where application 750 is being displayed on a local desktop 755 with features of the local device OS 715, while another application 745 has features of the virtual machine OS 760. In some scenarios, these displayed applications (i.e. applications 745 and 750) are two different instances of the same underlying application, but visual differences exist between these two instances due to the underlying OS that is being used. In other scenarios, the two applications 745 and 750 may be different applications.

In some embodiments, the application includes user interface elements that change appearance based on the type of OS for the remote virtual desktop. In other words, the native OS for the local device and the OS for the virtual machine may be different, which could affect the display of the application and user interface elements included therein. For example, a user interface element included in the application may be a tab control bar, which is displayed in one aesthetic configuration for a first type of OS that is native to the local device (e.g., local device OS 715), but which appears differently when the virtual application is hosted on a virtual machine with a second type of OS (e.g., virtual machine OS 760).

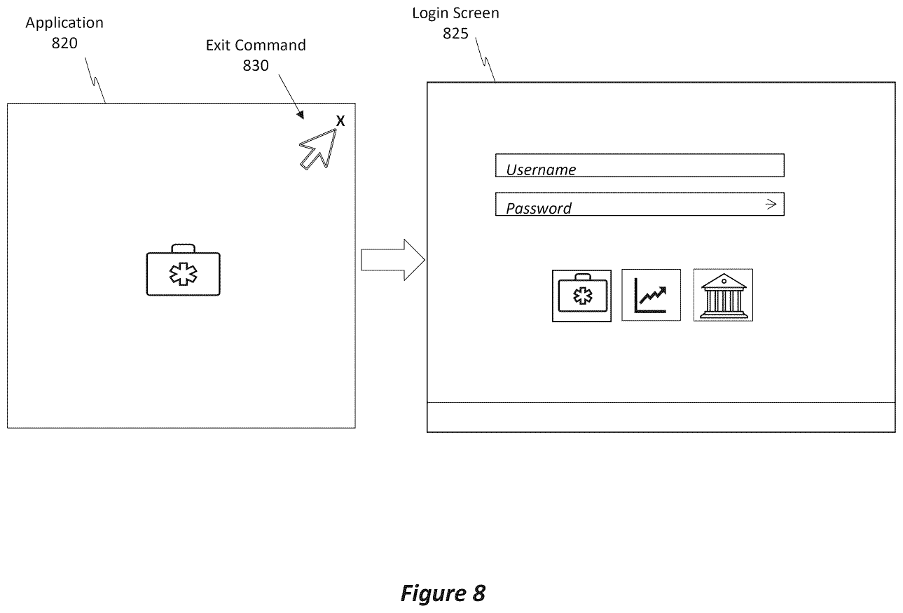

In some instances, a user may wish to switch from their preferred or currently in use application to another virtual application or log off of their local device altogether. FIG. 8 shows a global log-off feature that similarly saves a user time by avoiding a sequential log off procedure. A user selects an exit command 830 for the application 820, here a default application, causing the system to close the remote virtual desktop, end the current cloud session, and return to the login screen 825. In FIG. 8, the exit command 830 is a user selected X button, but in other implementations, the exit command may be a keyboard shortcut, voice command, gesture, or other suitable command or a different user interface element to close the application. These other options can be provided to the user to enable the user to log off of the application and/or the local device.

The exit command 830 for the application 820 closes the application, logs the user off of the remote virtual desktop, and returns the user to the login screen. Optionally, if the application requires heightened or elevated credentials to access currently locked or restricted features of the application (restricted in view of the original credentials that were entered), in some implementations, an exit command 830 will also log a user out of the application, thereby returning the user to the login screen so the user can then enter the heightened credentials to access the previously restricted content. In some instances, the login screen 825 can then be used to log into a separate application or the device's local desktop. For example, a user can select a different application tile on login screen 825, which are representative of the application tiles 505, 510, and 515 of FIG. 5.

In some instances, the second application is hosted by a second virtual machine, distinct from a first virtual machine hosting the first application. In this case, the user enters a second set of user credentials in the login screen associated with a second remote virtual desktop for the second virtual machine. Then, in response to receiving the second user credentials, the computer will display the second application. In some implementations, the second application may be hosted by the first virtual machine. Therefore, in some implementations, the first virtual machine may host any number of different applications, including the first and second applications.

### Example Process Flow

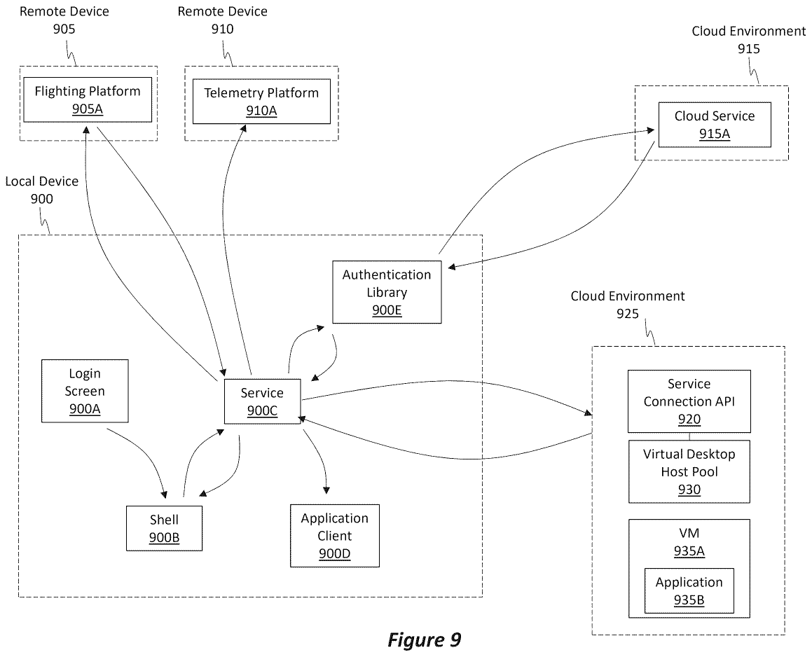

Having just described some of the principles at a high level, attention will now be directed to FIG. 9, which illustrates an example process flow of some of the communications and actions that can occur between a local device 900, one or more remote devices (e.g. remote devices 905 and 910), and one or more cloud environments (e.g., cloud environments 915 and 925). In some instances, the remote devices 905 and 910 may be the same device while in other instances they are different devices. Similarly, in some instances, the cloud environments 915 and 925 may be the same cloud environment while in other instances they are different environments.

Local device 900 displays a login screen 900A, which is representative of any of the login displays previously discussed, including login screen 325 of FIG. 3. Login screen 900A is provided by the local device's operating system. The user is expected to sign into a session by entering her credentials on the login screen 900A. In accordance with the disclosed principles, the local device 900 has been configured (e.g., by an IT administrator) to enable the login to virtual application mode, which is the mode that enables the local device 900 to access the user's virtual application based on input provided on the login screen 900A.

The credentials entered by the user on login screen 900A are credentials associated with a remote virtual desktop. Those same credentials are used to trigger the connection between the local device 900 and the user's application 935B through the virtual machine 935A that hosts the virtual application and corresponding remote virtual desktop; thus, the credentials can be used to validate or authenticate the user with the cloud service hosting the virtual machine.

In some instances, the local device 900 is a type of terminal device or a public device that may be shared by multiple users. Sometimes, the local device 900 is placed in a lockdown mode or a restricted mode. While in this mode, the local device 900 will typically prevent users from being able to login to the local device 900. Instead, while this mode is active, users will be able to access only the application on the remote virtual desktop.

Thus, the local device 900 can be a dummy terminal or a device structured primarily for remote streaming purposes. Recall, the local device 900 receives a streamed image of the application. The infrastructure that is hosting and supporting the application is in the cloud environment (e.g., cloud environment 915 or 925). A majority of the compute, memory, and other operations are performed in the cloud, and the local device 900 can be a simplified device having, as its primary function, features related to streaming content of virtual applications.

Receiving the user credentials at the login screen 900A triggers the local device's 900 shell 900B to initiate a login process. In accordance with the disclosed principles, the local device 900 is further configured to include a service 900C (aka a client application), which is representative of the service 110 from FIG. 1. The service 900C can be implemented as a part of the shell 900B or as an add-on to the shell 900B. In some cases, various APIs may exist to bridge the service 900C to the shell 900B. The shell 900B is configured to call the service 900C and to inform the service 900C that a user is logging into her remote virtual desktop to stream the corresponding virtual application, based on the receipt of the user's credentials on the login screen 900A. Thus, the shell 900B can optionally activate the service 900C.

Service 900C calls an authentication library 900E. The authentication library 900E is tasked with acquiring a token for the user, where that token is generated based on the entered user credentials. The authentication library 900E uses that token to validate the user with the cloud service 915A in the cloud environment 915. For instance, this validation can include determining that the user has a cloud service that includes a remote virtual desktop.

After a determination is made that the user is validated, the service 900C then communicates with a service connection API 920 residing in the cloud environment 925. The service connection API 920 is tasked with identifying a particular virtual application for the user that is associated with the remote virtual desktop. The service connection API 920 is enabled to access a host pool of applications in the virtual desktop host pool 930. For instance, it might be the case that the user has set a default application for the remote virtual desktop, so that the default application is selected from the virtual desktop host pool 930. If there is a selection of applications presented on the login screen, as in FIG. 5, the application selected by the user is selected. In some cases, the API 920 is additionally tasked with first identifying a virtual machine that is hosting the virtual desktop host pool 930.

After an application for the user is identified, the service 900C communicates with an application client 900D. The application client 900D is tasked with launching a hosting application on the local device 900 and establishing a connection with the application so that the image of that application may be streamed to the local device 900.

In some alternative embodiments, such as while an image of an application is being streamed to the local device 900, the embodiments are able to connect with a flighting platform 905A, which may reside on the remote device 905, and a telemetry platform 910A, which may reside on the remote device 910. The flighting platform 905A is configured to determine what features are available to a given virtual desktop and a given user. In some instances, the flighting platform 905A can be viewed as a type of A/B test.

Generally, A/B testing refers to a process in which two (or more) versions of a feature are provided to a set of users. A first set of users is provided with the “A” version of the feature, and the second set of users is provided with the “B” version of the feature. The test collects data to determine which version of the feature has a bigger impact on its respective set of users. The data is then used to drive various business decisions and, perhaps, even to drive the evolution of the feature and application. Thus, the flighting platform 905A can be used to enable various features on certain devices.

The telemetry platform 910A is configured to collect metric and/or telemetry data. This data can be used to provide feedback to better control the operations of the remote virtual desktop, the application, and/or the connection between the local device 900 and the remote virtual desktop. In some cases, the telemetry data can also be used to determine how to resolve various issues, such as initial connection issues (e.g., during the process in which a user is first attempting to access an application) or subsequent issues that may occur when a break to the connection between the local device 900 and the application occurs.

### Reconfiguring the Local OS Shell

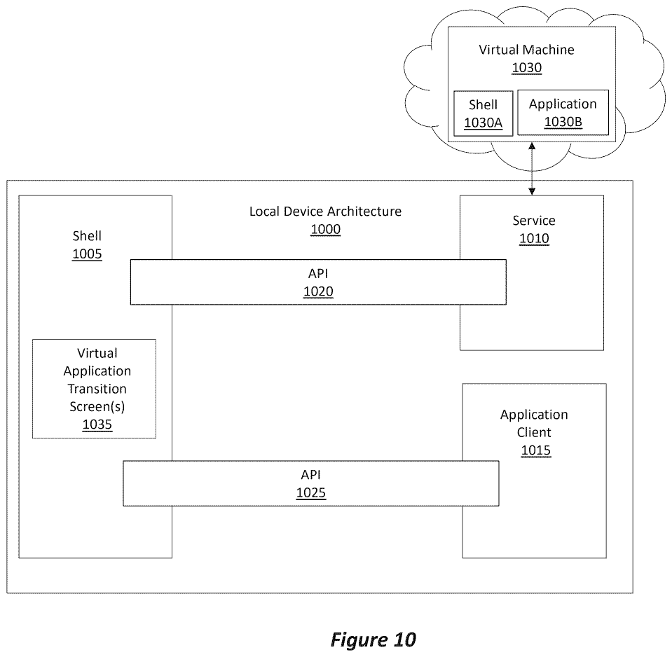

Embodiments described herein are enabled to reconfigure the OS's local shell. Thus, instead of starting up in a localized manner (e.g., by triggering the system's native explorer process, which is a process that shows a computer's taskbar, start menu, and other items on a desktop) when the user logs in, the embodiments trigger a connection to a virtual application and then stream an image of that application to the local device; the device is now configured to perform a different process during the login sequence. FIG. 10 shows an example architecture of a device configured to connect to an application on a remote virtual desktop.

FIG. 10 shows a local device architecture 1000, which is representative of the architecture of the local device 900 of FIG. 9. The architecture is shown as including a shell 1005, which corresponds to the shell 900B in FIG. 9; a service 1010, which corresponds to the service 900C; and an application client 1015, which corresponds to the application client 900D.

A first API 1020 is provided to facilitate communications between the shell 1005 and the service 1010. Similarly, a second API 1025 is provided to facilitate communication between the shell 1005 and the application client 1015. As described previously, the service 1010 is tasked with identifying and connecting to an application 1030B hosted on a virtual machine 1030. The virtual machine is associated with a corresponding shell, shown by shell 1030A. During the connection phase, the shell 1005 can trigger the display of one or more application transition screens 1035, which can be a transition screen representative of that of FIG. 6A, for example.

The service 1010 is optionally registered with the shell 1005, and the service 1010 may be viewed by the shell 1005 as being a PC, yet the service 1010 is making a call to a different PC (i.e. the virtual machine 1030). Generally, the shell 1005 is operated by the device's OS. The shell 1005 manages the transition screens 1035. The shell 1005 also cooperates with the service 1010, which can optionally be a type of pluggable system, API, or component. After the user is logged in to the application, the user is then instead interacting with the shell 1030A of the virtual machine 1030.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

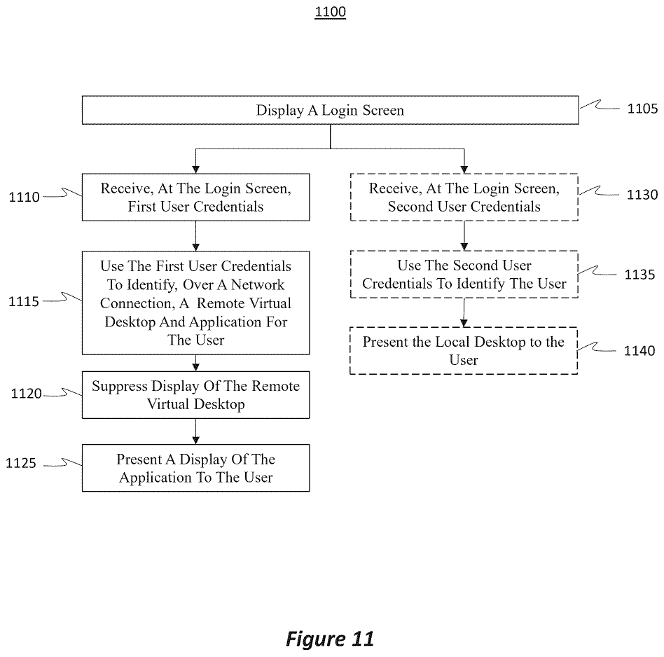

Attention will now be directed to FIG. 11, which shows a flowchart of an example method 1100 for configuring a login screen, which is native to an OS of the computer system, for enabling a user to boot directly to a virtual application. Method 1100 can be implemented in the architecture 100 of FIG. 1, and more particularly by the device 105. Many of the acts can be implemented by the service 110, while some of the acts may be implemented by the device OS 115, or by that OS's shell.

Method 1100 first shows act 1105 of causing a computer system to display a login screen. This login screen is native to the OS of the computer system. In some implementations, the computer system is operating in a lockdown mode that prevents the user from locally logging into the computer system. The OS of the computer system includes a shell application. A client service or application, which facilitates connection with the user's virtual desktop, is integrated with the shell application of the computer system's OS. For example, various APIs may exist to enable the service to communicate with the shell. The client service or application can, as one example option, be registered so as to appear as a PC by the OS, and thereby enable the computer system to host a user session for the user, where the user session includes streaming an image of the user's virtual application.

Act 1110 includes receiving, at the login screen, a first set of user credentials. In some instances the user credentials are for the remote virtual desktop associated with the user who entered the user credentials and a default application. The term “associated” should be interpreted broadly. In one scenario, the user credentials may comprise a username and password obtained from a password manager service. In this example case, there may be a pre-provisioned virtual machine that can be accessed using the username and password. In some implementations, the user credentials may include a license code. In this case, when there is no pre-provisioned virtual machine for the user, the user may then be provided access to a virtual machine with a license code. Both of these examples describe scenarios in which a virtual desktop is or can be “associated” with the user. This association may be a pre-existing association or one that is created at the time the user provides the user credentials (e.g., the license code).

Act 1115 includes using the first set of user credentials (e.g., credentials 130) to identify, over a network connection, a remote virtual desktop and an application for the user. The identification process can involve initially validating or authenticating that the user has access to a cloud service. If the user has a cloud service, then the embodiments check whether a remote virtual desktop exists for the user. The user may also be associated with multiple remote virtual desktops or multiple applications. The embodiments, as discussed previously, are able to intelligently select a particular application and associated remote virtual desktop to stream to the user's device. Optionally, the same user credentials used to log into the remote virtual desktop can also be used to log in to the application, such as to the user's profile in the application.

After the application is selected, act 1120 involves suppressing a display of the remote virtual desktop as well as the native desktop. Thus, both the remote desktop and the local desktop are suppressed from being displayed. In some implementations, while the display of the remote virtual desktop (and native desktop) is suppressed, the embodiments display a login transition screen, for example, the login transition screens of FIGS. 6A and 6B.

Act 1125 includes presenting a display of the application to the user. This involves streaming, over a network connection, an image of the application. This occurs after the user's credentials for the remote virtual desktop are validated by the remote cloud service. Recall, the remote virtual desktop resides in the cloud environment, but the application was accessed via the computer system's login screen. Thus, the system's streaming functionality is used to receive the stream from the cloud service hosting the virtual application.

In some cases, the computer system is a shared terminal usable by multiple users. The computer system can thus enable each of the users to log in to that user's corresponding virtual desktop from the login screen, which is native to the OS of the computer system, and to then obtain access to the default application for that user. In some cases, the computer system is governed by a shared mode policy, which controls or governs what features or options are available to users using the computer system.

Method 1100 may include additional optional acts for a user to log into the local desktop instead of the virtual application. In act 1130, the user enters a second set of user credentials corresponding to the local desktop (e.g., credentials 135). The computer system may still communicate with the cloud environment to identify the user with the second set of credentials. For instance, if user profile data for the local device is stored in the cloud environment, the embodiments may access the user profile data to identify the user in act 1135. Finally, in act 1140, the alternative method presents the local desktop to the user. In this case, the user is then able to use their local device in a conventional manner.

Method 1100 may include additional acts. For instance, one act includes causing, in response to receiving the first user credentials at the login screen, the OS shell to call a service (e.g., the service 110 of FIG. 1, service 900C of FIG. 9, or service 1010 of FIG. 10) residing on the computer system. Another act can include causing the service to obtain a token for the user. The service may then use the token to validate the user with the cloud environment. In response to validation of the user, the service may then trigger the identification of the remote virtual desktop and the application in the cloud environment.

Another act may include providing flighting information to a first remote service, device, or platform. The flighting information details which features associated with the virtual desktop and/or connection to the virtual desktop are enabled for the user. Another act may include providing telemetry data to a second remote service, device, or platform. Optionally, the second remote service may be the same as the first remote service. The telemetry data is usable to determine what conditions resulted in an error. For instance, a condition may occur where the connection between the device and the virtual desktop is broken or otherwise terminated. The telemetry data can provide information regarding the circumstances under which the condition occurred. The telemetry data can also be relied on to determine what subsequent screen is to be presented to the user (e.g., display the login screen or a login transition screen).

In some cases, a type of OS of the computer system might be different than a type of an OS for the virtual machine that is hosting the application. For instance, the computer system might have a first type of OS (e.g., Windows) while the virtual machine might have a second type of OS (e.g., Linux, iOS). The application may display features of the OS of the virtual machine on the physical display of the local device through the streamed image. In some cases, the display of the application can be tailored based on either the OS of the local computer or the OS of the remote virtual machine.

In some embodiments, though the display of the remote virtual desktop is being suppressed, various peripheral devices of the computer system can still be controllable through a remote virtual desktop of the virtual machine that is hosting the application. As some examples, the peripheral devices may include one or more of a mouse, a keyboard, a speaker, a microphone, a display, or any other type of peripheral device. Thus, optionally, the user can control the local peripheral devices connected to the local device from a taskbar of the remote virtual desktop of the virtual machine that is displayed over the application, while the rest of the remote virtual desktop remains suppressed. These peripheral devices are used to interact with the application.

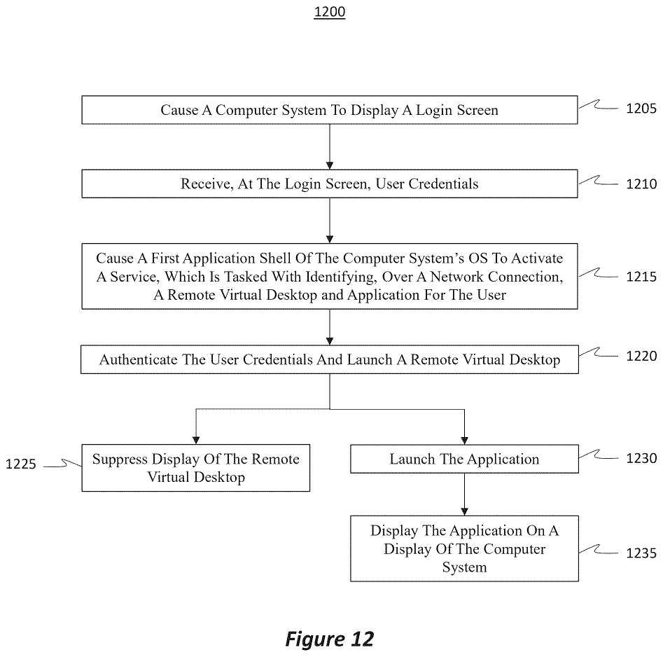

FIG. 12 shows a flowchart of an example method 1200 for configuring a login screen, which is native to an OS of a computer system of a local device, to enable a user to access a virtual application that resides in a cloud environment. Method 1200 can be implemented, for example, by the device 105 of FIG. 1.

Act 1205 of method 1200 includes causing the computer system to display the login screen. As indicated above, this login screen is native to the OS of the computer system. Act 1210 includes receiving, at the login screen, user credentials. The user credentials are for the remote virtual desktop associated with the user who entered the credentials. As described previously, this association may be a pre-existing association or one that is created at the time the user provides the user credentials, such as through a license code. The user credentials can be one or more of a username and password; a license code; a QR code; or other information for validating identity.

Act 1215 includes causing a first application shell of the computer system's OS to activate an application service or client. The service is tasked with identifying, over a network connection, the virtual machine and virtual application for the user. The virtual machine that hosts the virtual application resides in the cloud environment, and the virtual application is associated with the remote virtual desktop for the virtual machine.

Act 1220 includes authenticating the user credentials and launching a remote virtual desktop. After the user credentials are authenticated and the remote virtual desktop is launched, the following method acts 1225 and 1230 may be either concurrent or sequential.

Act 1225 includes suppressing a display of the remote virtual desktop, so the user does not see the remote virtual desktop. In some embodiments the method 1200 includes additional acts relating to displaying a login transition screen while the method acts 1225 and 1230 are being performed. Optionally, the login transition screen has a threshold level of similarity relative to a login transition screen that would otherwise be displayed if the user were locally logging in to the computer system, to enable the user to recognize that the login process is being performed with respect to the user's remote virtual desktop and booting of the virtual application. Act 1230 includes launching the application.

Finally, act 1235 includes displaying the application on a display of the computer system. The computer system streams an image of the application from the virtual machine residing in the cloud environment to the display of the local device, such that the user may interact with the virtual application on their local device.

Accordingly, the disclosed embodiments are directed to integrating the connection to a virtual application into an operating system of a local device. This integration is achieved by providing a dynamic login process that allows users to log in to an application from the login screen of the local device. In this regard, users are able to log directly into the virtual desktop as the primary operating system experience on a device.

### Example Computer/Computer Systems

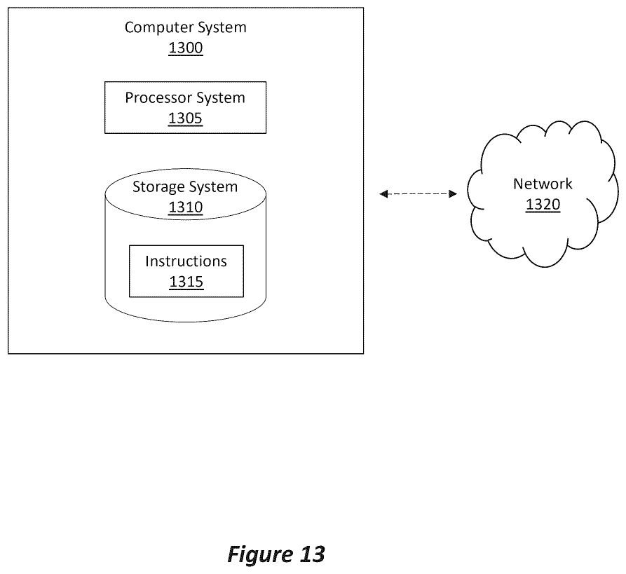

Attention will now be directed to FIG. 13 which illustrates an example computer system 1300 that may include and/or be used to perform any of the operations described herein. Computer system 1300 may take various different forms. For example, Computer system 1300 may be embodied as a tablet, a desktop, a laptop, a mobile device, or a standalone device, such as those described throughout this disclosure. Computer system 1300 may also be a distributed system that includes one or more connected computing components/devices that are in communication with Computer system 1300. Computer system 1300 can be implemented as the cloud environment 140 or the device OS 115 of FIG. 1. Additionally, Computer system 1300 can implement service 110.

In its most basic configuration, Computer system 1300 includes various different components. FIG. 13 shows that computer system 1300 includes a processor system 1305 that includes one or more processor(s) (aka a “hardware processing unit”) and a storage system 1310.

Regarding the processor(s) of the processor system 1305, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1300. The different components, modules, engines, and services described herein may be implemented as objects or processors that execute on computer system 1300 (e.g. as separate threads).

Storage system 1310 may be physical system memory, which may be volatile, non-volatile, or some combination of the two. The term “memory” may also be used herein to refer to non-volatile mass storage such as physical storage media. If computer system 1300 is distributed, the processing, memory, and/or storage capability may be distributed as well.

Storage system 1310 is shown as including executable instructions 1315. The executable instructions 1315 represent instructions that are executable by the processor(s) of computer system 1300 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1300 may also be connected (via a wired or wireless connection) to external sensors (e.g., one or more remote cameras) or devices via a network 1320. For example, computer system 1300 can communicate with any number devices or cloud services to obtain or process data. In some cases, network 1320 may itself be a cloud network. Furthermore, computer system 1300 may also be connected through one or more wired or wireless networks to remote/separate computer systems(s) that are configured to perform any of the processing described with regard to computer system 1300.

A “network,” like network 1320, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1300 will include one or more communication channels that are used to communicate with the network 1320. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present techniques may be embodied in other specific forms without departing from their characteristics. The described embodiments are to be considered in all respects only as illustrative and not restrictive. The scope of the present techniques are, therefore, indicated by the appended claims rather than by the foregoing description. All changes which come within the meaning and range of equivalency of the claims are to be embraced within their scope.

What is claimed is:

1. A computer system that facilitates user access to an application on a remote virtual desktop, said computer system comprising:
one or more processors; and
one or more hardware storage devices that store instructions that are executable by the one or more processors to cause the computer system to:
display a login screen, which is native to an operating system (OS) of the computer system;
receive user credentials via the login screen, wherein the user credentials are associated with the remote virtual desktop, and wherein the remote virtual desktop is associated with the application and a user from whom the user credentials are received;
authenticate the user credentials over a network connection;
after authenticating the user credentials, launch the remote virtual desktop;
suppress a display of the remote virtual desktop; and
while the display of the remote virtual desktop is being suppressed:
launch the application; and
display a user interface of the application on a display of the computer system.

2. The computer system of claim 1, wherein a single virtual machine hosts the remote virtual desktop and the application.

3. The computer system of claim 2, wherein user profile data related to the remote virtual desktop and the application is stored in a cloud environment that hosts the remote virtual desktop and the application.

4. The computer system of claim 2, wherein a first OS type of the OS that is native to the computer system is different than a second OS type for an OS for the virtual machine.

5. The computer system of claim 2, wherein the application includes one or more user interface elements, and wherein an appearance of the one or more user interface elements changes based on whether the OS for the virtual machine is of a first type or a second type.

6. The computer system of claim 1, wherein the application is a web browser.

7. The computer system of claim 1, wherein the application is one of: a software as a service (SaaS) application, an infrastructure as a service (IaaS) application, or a platform as a service (PaaS) application.

8. The computer system of claim 1, wherein the application, after launching, loads a state of the application that was previously saved.

9. The computer system of claim 1, wherein the user credentials include a username and a password obtained from a password manager service, and wherein the username and password are auto populated into a username field and a password field of the login screen.

10. The computer system of claim 1, wherein the instructions are further executable to cause the computer system to:
identify the application as being associated with the remote virtual desktop by receiving a selection of an application icon that is displayed on the login screen, and wherein the application icon corresponds to the application.

11. The computer system of claim 1, wherein the application associated with the remote virtual desktop is a default application that is selected during a prior setup process.

12. The computer system of claim 1, wherein the instructions are further executable to cause the computer system to:
identify the application as being associated with the remote virtual desktop by receiving a selection of an application icon that is displayed on the login screen, wherein the application icon corresponds to the application, and wherein the application icon is one of a plurality of application icons that are simultaneously displayed on the login screen.

13. The computer system of claim 1, wherein the instructions further cause the computer system to, in response to receiving an exit command for the application:
close the application;
log the user off the remote virtual desktop; and
return the user to the login screen.

14. A method to facilitate user access to an application on a remote virtual desktop, said method comprising:
displaying a login screen, which is native to an operating system (OS) of a computer system;
receiving user credentials via the login screen, wherein the user credentials are associated with the remote virtual desktop, and wherein the remote virtual desktop is associated with the application and a user from whom the user credentials are received;
authenticating the user credentials over a network connection;
identifying the remote virtual desktop and the application on the remote virtual desktop;
after authenticating the user credentials and identifying the remote virtual desktop and the application, launching the remote virtual desktop;
suppressing a display of the remote virtual desktop; and
while the display of the remote virtual desktop is being suppressed:
launching the application, which is hosted by the remote virtual desktop; and
displaying the application on a display of the computer system.

15. The method of claim 14, wherein the remote virtual desktop is hosted on a first virtual machine, and wherein the method further includes:
in response to receiving a selection of an exit element of the application, (i) logging the user off of the application, (ii) logging the user off of the remote virtual desktop, and (iii) logging the user off of a local desktop;
subsequently, receiving second user credentials in the login screen; and
in response to receiving the second user credentials, displaying a second application that is hosted by a second virtual machine.

16. The method of claim 15, wherein the login screen displays a first application tile corresponding to the application and a second application tile corresponding to the second application, and wherein launching of either one of the application or the second application is dependent on whichever one of the first or second application tiles in the login screen is selected via user selection.

17. One or more hardware storage devices that store instructions that are executable by one or more processors to cause the one or more processors to:
display a login screen, which is native to an operating system (OS) of a computer system of the one or more hardware storage devices and the one or more processors;
receive user credentials via the login screen, wherein the user credentials are associated with a remote virtual desktop, and wherein the remote virtual desktop is associated with the application and a user from whom the user credentials are received;
authenticate the user credentials over a network connection;
after authenticating the user credentials, launch the remote virtual desktop;
suppress a display of the remote virtual desktop; and
while the display of the remote virtual desktop is being suppressed:
launch the application, which is hosted by the remote virtual desktop; and
display the application on a display of the computer system.

18. The one or more hardware storage devices of claim 17, wherein, while the remote virtual desktop and the application are launching, a login transition screen is displayed.

19. The one or more hardware storage devices of claim 18, wherein the login transition screen includes an element for displaying a status of a connection process for the application.

20. The one or more hardware storage devices of claim 18, wherein the application maintains user profile information for the user, and wherein launching the application includes fetching the user profile information.
